(19) United States
(12) Patent Application Publication
(10) Pub. No.: US 2004/0130060 A1
(43) Pub. Date: Jul. 8, 2004

(54) Process and apparatus for removing NMMO-water mixture collecting in the interior of a tubular film produced by the NMMO process

(76) Inventors: Klaus-Dieter Hammer, Mainz (DE); Herbert Gord, Ingelheim (DE); Rainer Neeff, Wiesbaden (DE); Klaus Berghof, Rudolstadt-Schwarza (DE); Markus Eilers, Wietmarschen-Lohne (DE); Eberhard Taeger, Weissbach Bei Rudolstadt (DE)

Correspondence Address: Richard S. Roberts, Roberts & Mercanti, L.L.P., P.O. Box 484, Princeton, NJ, 08542-0484, US

(21) Appl. No.: 10/712,421

(22) Filed: Nov. 12, 2003

(30) Foreign Application Priority Data
Nov. 12, 2002 (DE) 102 52 387.8

(51) Int. Cl. B29C 47/20; B29C 71/00

(52) U.S. Cl. 264/209.1; 264/563; 264/211.12; 264/232; 264/233; 264/234; 264/340; 264/345; 425/68; 425/71

(57) ABSTRACT

An apparatus for removing NMMO-water mixture which collects in the interior of a tubular film which is produced by the NMMO process comprises a spinning vat and a wash vat. Between the two vats is situated a conveyor belt which circulates endlessly over two rollers. The conveyor belt is directed upward at an incline from the spinning vat to the wash vat. The tubular film, in the interior of the spinning vat, is passed vertically downward, then reversed and conducted vertically out of the spinning vat and passes over the inclined conveyor belt into the wash vat. Above the conveyor belt is situated a spray device having spraying nozzles from which wash liquid at a temperature between 60 and 80° C. is sprayed onto the tubular film which is transported via the conveyor belt.

### BACKGROUND OF THE INVENTION

1. Field of the Invention

The invention relates to a process and an apparatus for removing NMMO-water mixture collecting in the interior of a tubular film produced by the N-methylmorpholine N-oxide (NMMO) process.

2. Description of the Related Art

The tubular film can be either a non-edible or edible tubular film which is used in each case as sausage casing in the production of large- or medium-caliber sausage products. The patent DE 197 37 113 describes the production of cellulosic tubular films by extrusion and regeneration of a solution of cellulose in NMMO.

Furthermore, German application DE 101 29 539 which was unpublished at the priority date of the present application, describes that edible tubular films may be produced by the NMMO process which, in addition to cellulose, further comprise at least one dissolved protein and at least one filler which is suspended in the NMMO solution.

According to the patent DE 197 37 113, the spinning solution is extruded through a ring-shaped die to give a tubular film which is then passed vertically downward into a spinning bath within a spinning vat. To avoid the insides of the tubular film from sticking together, a pressure is maintained in the interior of the tubular film and an aqueous NMMO solution is introduced into the tubular film. The tubular film, at the bottom of the spinning vat, is reversed over a roll and is taken off upward, with the upward takeoff preferably being at an incline, but can also be performed vertically. For this a takeoff roll is present over which the laid-flat tubular film runs and is introduced horizontally into a wash path which consists of a plurality of wash vats through which the tubular film is passed in a serpentine manner and is cleaned by means of water from the residues of NMMO still adhering. During the cleaning process the NMMO-water mixture collecting in the interior of the tubular film must be removed. This is achieved as early as in the spinning vat by extracting the liquid collecting in the interior of the tubular film at the internal bath surface of the tubular film descending from the ring-shaped die vertically to the reversal roll. From the wall of the tubular film the NMMO-water mixture exits into the interior of the tubular film. In the conventional process conveyance of the tubular film from the spinning vat to the first wash vat, only the liquid being released up to the first wash vat can be removed. The liquid being released in the tubular film interior after passing the reversal roll at the end of the spinning vat collects and must be removed by opening the tubular film at intervals, which is customarily performed by cutting open the tubular film. Before and after the incision of the tubular film, changes in the tubular film diameter occur, as a result of which the production of tubular film pieces as long as possible of constant caliber is not achieved.

It is an object of the invention to improve a process of the type described at the outset in such a manner that the liquid which is collected in the interior of a tubular film can be continuously taken off before entry of the tubular film into a wash path.

This object is achieved according to the process in such a manner that the tubular film, after exit from a spinning vat is passed over a path upward at an incline to a wash vat and that NMMO-water mixture situated in the tubular film interior flows back via the inclined path into a part of the tubular film which is descending vertically in the spinning vat and from there is sucked out. By means of the fact that the tubular film, after exit from the spinning vat, is passed over a relatively long path in open form and constantly ascending, the liquid exiting from the walls of the tubular film can flow back to the spinning vat in the form of the NMMO-water mixture in the tubular film interior. In the spinning vat the liquid columns in the descending and ascending tubular film parts communicate, so that the liquid can be removed via the above-described inner bath extraction in the descending tubular film part.

In an embodiment of the process, to compact the tubular film wall and for accelerated depletion of the NMMO-water mixture in the tubular film, the tubular film is treated with hot wash liquid at from about 60° C. to about 80° C. Expediently, the treatment with hot wash liquid is performed along the path and this is achieved by spraying the tubular film with the hot wash liquid along the path. Advantageously, the wash liquid is water.

In an embodiment of the process, the tubular film is continuously passed from the spinning vat upward to the wash vat across the path at an angle of from about 10° to about 60° to the horizontal.

In a further embodiment of the process, the tubular film is passed over a serpentine-like path from the spinning vat to the wash vat. Expediently, the inclination of the path is chosen to be adjustable.

Extracting the NMMO-water mixture from the interior of the tubular film by suction would be the simplest to implement per se if the tubular film could be moved vertically upward over as long a distance as desired. However, this is not possible predominantly for two reasons, since firstly at relatively high speed of the tubular film internal liquid is carried along upward and would thus be removed from the extraction, and secondly with increasing length of the tubular film, the latter would be too highly mechanically loaded under its own weight and the weight of the liquid contained in the tubular film wall, which could lead to stretching or tearing. Therefore, it is advantageous first to pass the tubular film ascending vertically from the spinning vat and then to transport it upward at an incline to the first wash vat, to bring the weight of the tubular film under control in this manner. The height of the vertical part of the tubular film must be chosen in a material-dependent manner, as a function of the composition and weight per unit area of the tubular film, so that the weight of the tubular film does not have disadvantageous effects with regard to constancy of caliber and the mechanical strength of the tubular film. In practice, the distance between the reversal close to the bottom of the spinning vat and the takeoff roll situated above the spinning vat is from about 1 to about 5 m, in particular from about 2 to about 3 m. The upper takeoff roll is at the same time a support roll for the conveyor belt on which the tubular film is laid flat and transported upward at an incline.

In the transport of the tubular film, it is necessary to heed the fact that this tubular film, in the wet state, can bear only a very low mechanical load. The equipment moving the tubular film through the individual treatment stages, such as spinning vat, wash vat, plasticizer vat, dryer, conditioner, must therefore operate particularly gently. For this it is expedient for all conveyor belts, reversal rolls in the individual baths, take off rolls and the like to be constructed so as to be controllable separately in very fine increments, and to support the transport, in addition, for example, by conveyor belts. After exit from the spinning vat, that is to say after passing through the spinning bath, the tubular film is passed through a wash path which comprises a plurality of wash vats in which the residues of NMMO are removed from the surface of the tubular film. The tubular film is then passed through a plasticizer vat which contains a solution of a plasticizer, preferably glycerol. Owing to the low stability of the wet tubular film, the customary drying in the inflated state cannot take place immediately. Only when the water content in the non-inflated tubular film has been reduced, does the stability increase to such an extent that final drying can be carried out. The substantially dewatered tubular film is, for this purpose, dried to a predetermined final moisture using hot air. During this process, the tubular film is inflated to the intended final caliber and dried with hot air. As a result of the drying in the inflated state, longitudinal and transverse stretching takes place, which establishes the essential properties such as strength and caliber constancy. After drying, the tubular film is wound up onto a storage roller.

The angle of climb along the inclined path is chosen, depending on the transport speed of the tubular film, such that the NMMO-water mixture in the tubular film interior flows off continuously in the direction of the spinning vat.

It is found that when the tubular film is sprayed from the outside with hot wash liquid, an accelerated exit of the NMMO-water mixture from the inner wall of the tubular film occurs. The temperature of the liquid must be at least about 60° C., with a maximum of up to about 80° C. When cold wash liquid is used it is found that the conveyor belt path must have a considerable length to achieve a noticeable effect in depleting the inner wall of the tubular film. By spraying the tubular film with hot water, a considerable compacting of the tubular film wall occurs, which is inevitably accompanied by accelerated release of the NMMO-water mixture from the wall, together with a consolidation of the tubular film wall. This procedure achieves a marked extension of the cutting times, since in the cleaning in the subsequent wash vats, a considerably smaller amount of NMMO-water mixture forms in the tubular film interior than in a process in which the tubular film is not sprayed with a hot wash liquid. The cut-free tubular film length can be increased by at least a factor of 4 compared with the known process in which the tubular film, after exit from the spinning vat, is transported into the wash path essentially horizontally over a take-off roll. For release of the NMMO-water mixture from the tubular film wall, the increased temperature of the wash liquid is critical, and less critical is the amount of wash liquid, and also not critical is the concentration drop of the NMMO solution in the interior of the tubular film between the spinning vat and first wash vat. At higher tubular film transport speeds, the NMMO-water mixture collecting in the tubular film interior will not flow back sufficiently quickly, even in the event of a steeper rise in conveyor belt from the spinning vat to the wash vat. It is then necessary to squeeze out the NMMO-water mixture situated in the tubular film wall and in the tubular film interior along the inclined path. In a variant of squeezing out using circulating pinch rolls, the NMMO-water mixture situated in the tubular film wall and in the tubular film interior is squeezed out at a variable speed against the running direction of the tubular film. Expediently, the NMMO-water mixture is squeezed out along the entire path at a plurality of sites or only at the higher end of the path. The adjustable speed at which the tubular film is squeezed out controls the removal of the NMMO-water mixture in the direction of the spinning vat. The pinch effect with simultaneous spraying with hot wash liquid accelerates the liquid egress from the tubular film wall. By means of the inventive process, the disadvantages of the conventional process are overcome which are that the depletion of the tubular film wall starts only gradually, as a result of which the collection of the NMMO-water mixture in the interior of the tubular film is distributed over the wash vats of the wash path. In the individual wash vat the tubular film is passed in a known manner in a serpentine-like route from the upper reversal rolls to the lower reversal rolls. In the course of this, on the lower reversal rolls, liquid bags form which hinder the smooth running of the tubular film through the wash path and undesirably lead to fluctuations in caliber. Since the liquid collecting in the liquid bags can no longer be recirculated toward the spinning vat, the tubular film must be cut open at regular intervals, as already mentioned above, in order to remove the liquid bags. In the conventional process this leads to short tubular film pieces and thus to high reject rates and to a considerably higher labor expenditure. In the inventive process the interfering liquid bags do not occur or occur only at substantially greater distances, as a result of which the caliber constancy is provided for very long tubular film pieces and furthermore the manufacturing costs are reduced.

### SUMMARY OF THE INVENTION

In the context of the present object, an apparatus for removing NMMO-water mixture collecting in the interior of a tubular film produced by the N-methylmorpholine-N-oxide (NMMO) process is provided, in which at least one conveyor belt which circulates endlessly over two rollers is disposed between a spinning vat and a wash vat and is directed upward at an incline toward the wash vat, and the tubular film which runs vertically downward in the interior of the spinning vat and, after its reversal, runs vertically upward, is passed over the inclined conveyor belt toward the washing vat.

In a further embodiment of the invention, a plurality of conveyor belts are disposed between the spinning vat and the wash vat, each conveyor belt circulates endlessly over two rollers and the conveyor belts are oriented in a zigzag shape one above the other. Expediently, in this embodiment, a reversal roller is present between in each case two conveyor belts and the tubular film is passed from the spinning vat in a serpentine-like manner over the top runs of the conveyor belts and the reversal rollers to the wash vat.

The invention further comprises a process for removing a liquid collecting in an interior part of a tubular film which comprises passing a tubular film having an interior part along a vertically descending path through a liquid in a spinning vat, and then removing the tubular film from the spinning vat along a vertically ascending path through the liquid in the spinning vat, and then passing the tubular film over an upwardly inclined path toward a wash vat such that liquid in the interior part of the tubular film flows back via the inclined path into a part of the interior of the tubular film which is in the vertically descending path in the spinning vat, and sucking liquid out of the part of the interior of the tubular film which is in the vertically descending path.

### BRIEF DESCRIPTION OF THE DRAWINGS

The invention is described in more detail below with reference to exemplary embodiments presented diagrammatically. In the drawings:

FIG. 1 shows diagrammatically a first embodiment of the inventive apparatus having a conveyor belt between spinning vat and first wash vat and a spraying device,

FIG. 2 shows a second embodiment of the inventive apparatus having a plurality of conveyor belts disposed in a zigzag manner one above the other between spinning vat and a first wash vat, and having a spraying device,

FIG. 3 shows a third embodiment of the apparatus of the invention having a conveyor belt between spinning vat and first wash vat and a pinch-roll pair,

FIG. 4 shows a fourth embodiment of the inventive apparatus in side view having a conveyor belt between spinning vat and first wash vat and having pinch rolls lying on the tubular film, which pinch rolls are disposed between two circulating chains.

FIG. 5 shows a plan view of the embodiment according to FIG. 4, and

FIG. 6 shows a plan view of a detail of a conveyor belt.

### DETAILED DESCRIPTION OF THE INVENTION

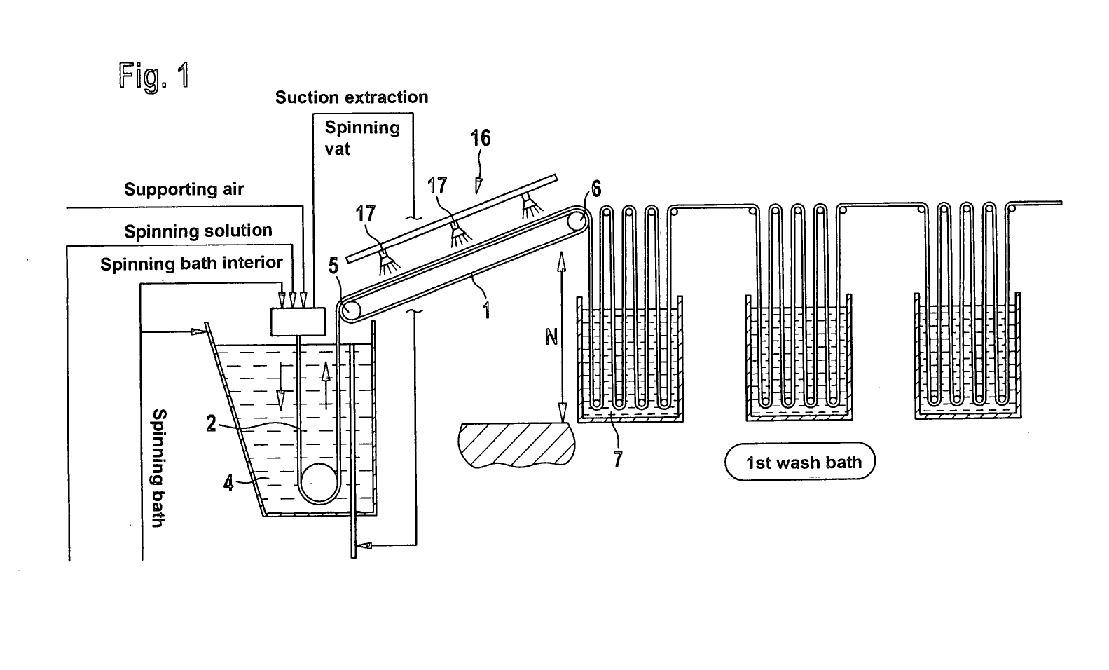

The apparatus of FIG. 1 comprises a spinning vat 4, a conveyor belt 1 and a first wash path having a first wash vat 7. The conveyor belt 1 circulates endlessly over two rollers 5 and 6 and is arranged sloping upward from the spinning vat to the wash vat 7. A tubular film 2 which is conducted vertically downward in the interior of the spinning vat 4 and, after its reversal, vertically upward, is transported via the sloping conveyor belt 1 to the wash vat 7 in which clean water is situated. The tubular film 2 which has been produced by the NMMO process is extruded through a ring die into the spinning bath of the spinning vat 4. The NMMO-water mixture situated in the tubular film interior, owing to the slope of the conveyor belt 1, flows back under the influence of gravity into the vertically ascending part of the tubular film 2 within the spinning vat 4 and, because of the communicating liquid columns in the ascending and descending part of the tubular film 2, passes into the descending part and from there is extracted by suction from the interior of the tubular film 2. The slope angle or the angle of climb of the conveyor belt is, depending on the running speed of the tubular film 2, to be selected such that the NMMO-water mixture in the tubular film interior continuously flows off to the spinning vat. Above the conveyor belt 1 is situated a spraying device 16 having spray nozzles 17 from which wash liquid is sprayed onto the tubular film 2. This wash liquid is heated to the region of from about 60° C. to about 80° C. By sprinkling the tubular film 2 with the hot wash liquid, which is primarily hot water, an accelerated release of NMMO-water mixture from the tubular film wall into the tubular film interior is achieved, that is to say the depletion of the tubular film wall and, in association, a shrinkage, which leads to considerable compacting of the tubular film wall, are achieved. The liquid temperature must be at least about 60° C. in order to achieve a noticeable effect. When cold wash liquid is used, that is to say at a temperature below about 60° C., it is found that the conveyor belt 1 would have to have a considerable length in order to achieve an effect comparable to hot wash liquid.

The conveyor belt 1 and the spray device 16 form a unit which can be pivoted vertically up and down about a lower pivoting point, as indicated by the double arrow N in FIG. 1. In this manner the slope of the conveyor belt 1 can be adjusted to from about 10° to about 60° to the horizontal.

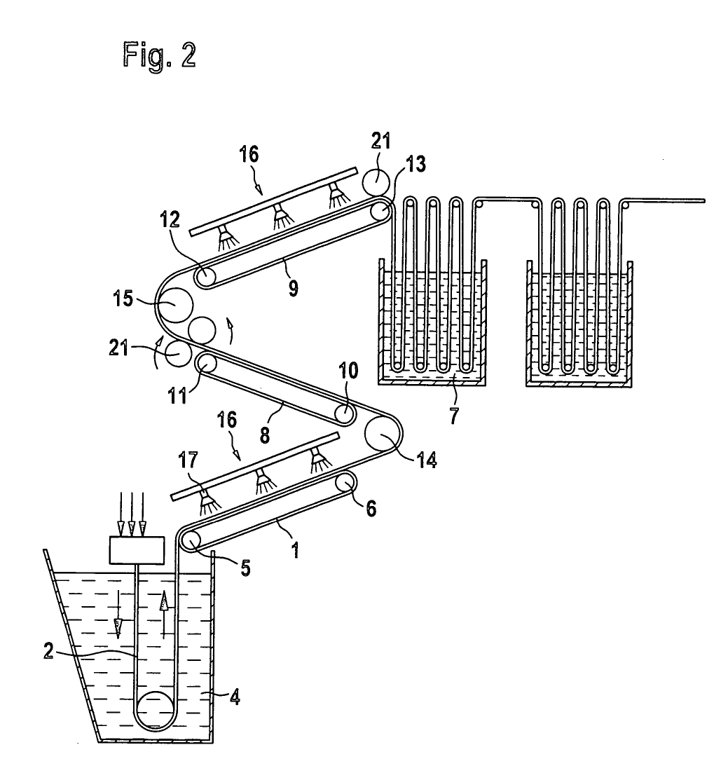

FIG. 2 shows a second embodiment of the apparatus which is modified compared with the first embodiment shown in FIG. 1. Between the spinning vat 4 and the first wash vat 7 is situated a conveying path which consists of conveyor belts 1, 8, 9 disposed one above the other in a zigzag manner. Between the conveyor belts 1 and 8 is situated a reversal roller 14 for the tubular film 2 and between the top end of the conveyor belt 8 and the lower end of the conveyor belt 9 is likewise situated a reversal roller 15. The tubular film is passed in a serpentine-like manner via the top runs of conveyor belts 1, 8, 9 and the reversal rollers 14, 15 into the wash vat 7. Parallel to, and above, the lower conveyor belt 1 is likewise situated a spray device 16 having a number of spraying nozzles 17. For reasons of better clarity, the figure does not show that a spray device 16 having a number of spraying nozzles 17 can also be mounted in each case above the middle conveyor belt 8 or the top conveyor belt 9.

An arrangement of the conveyor belt 1 which is directed sloping upward, and simultaneous squeezing-off of the conveyor belt will always be required if the tubular film 2 is transported at a speed higher than 35 m/min. Since the angle of inclination or slope angle of the conveyor belt is between 10° and 60° to the horizontal, at relatively high transport speeds of the tubular film 2, complete quantitative return of the NMMO-water mixture resulting in the tubular film interior can no longer be achieved, since the high transport speeds entrain too much NMMO-water mixture with the tubular film. The force of gravity alone is then no longer sufficient to return sufficient NMMO-water mixture via the slope of the conveyor belt 1. Comprehensive return is only achieved by squeezing out the NMMO-water mixture within the tubular film 2 in the direction of the spinning vat 4.

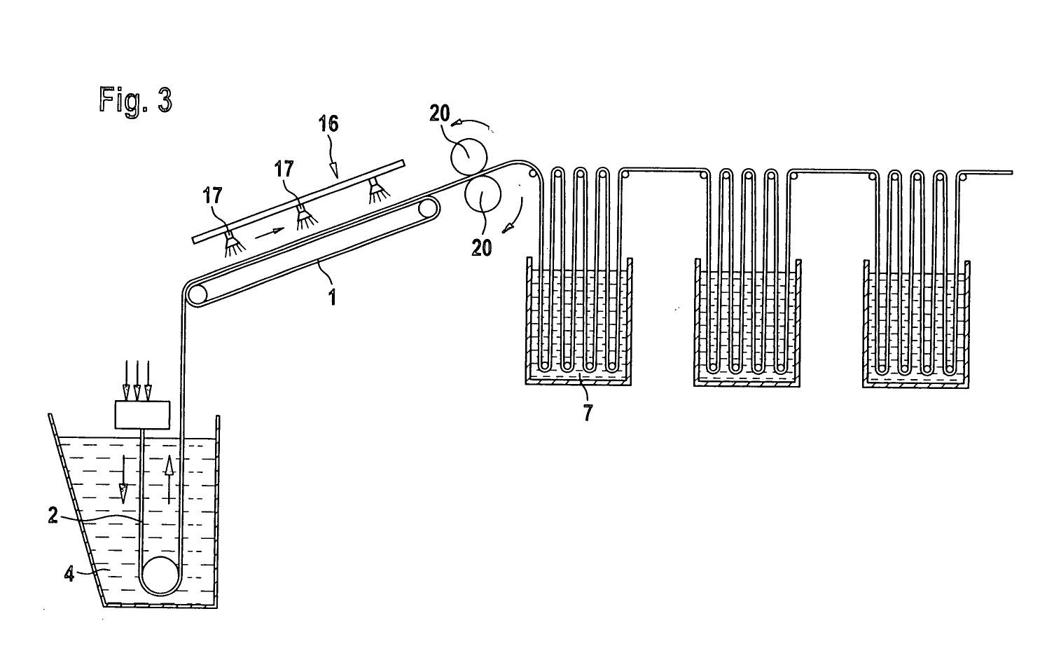

FIG. 3 shows a third embodiment of the apparatus of the invention. This embodiment is made up similarly to the embodiment of FIG. 1, and contains, in addition to the first embodiment, a further pinch-roll pair 20, 20 near the top end of the conveyor belt 1. The direction of rotation of the pinch-roll pair 20, 20 is the same as the transport direction of the tubular film 2 which is moved from the spinning vat 4 into the first wash vat 7 by the conveyor belt 1 which is directed sloping upward. Above the conveyor belt 1 is disposed the spray device 16 having the spraying nozzles 17. The rotational speed of the pinch-roll pair 20, 20 is variable, in order by this means to be able to squeeze out the NMMO-water mixture situated in the tubular film wall and in the tubular film interior at the same speed as the conveyor belt 1 in the running direction of the tubular film 2. The pinch effect with simultaneous sprinkling with hot liquid accelerates the liquid exchange or depletion of the wall of the tubular film 2 to a significant extent. This manner of carrying out the process achieves a considerable prolongation of the cutting times of the tubular film 2 for removing the liquid bags forming at the bottom reversals of the tubular film in the wash vats. In the subsequent wash vats of the wash path a considerably lower amount of NMMO-water mixture is present in the tubular film interior than in a conventional process in which the tubular film, after exiting from the spinning vat 4 is passed horizontally to the wash vat 7 via a reversal roll, without sprinkling the tubular film 2 with hot wash liquid on its route from the spinning vat 4 to the wash vat 7.

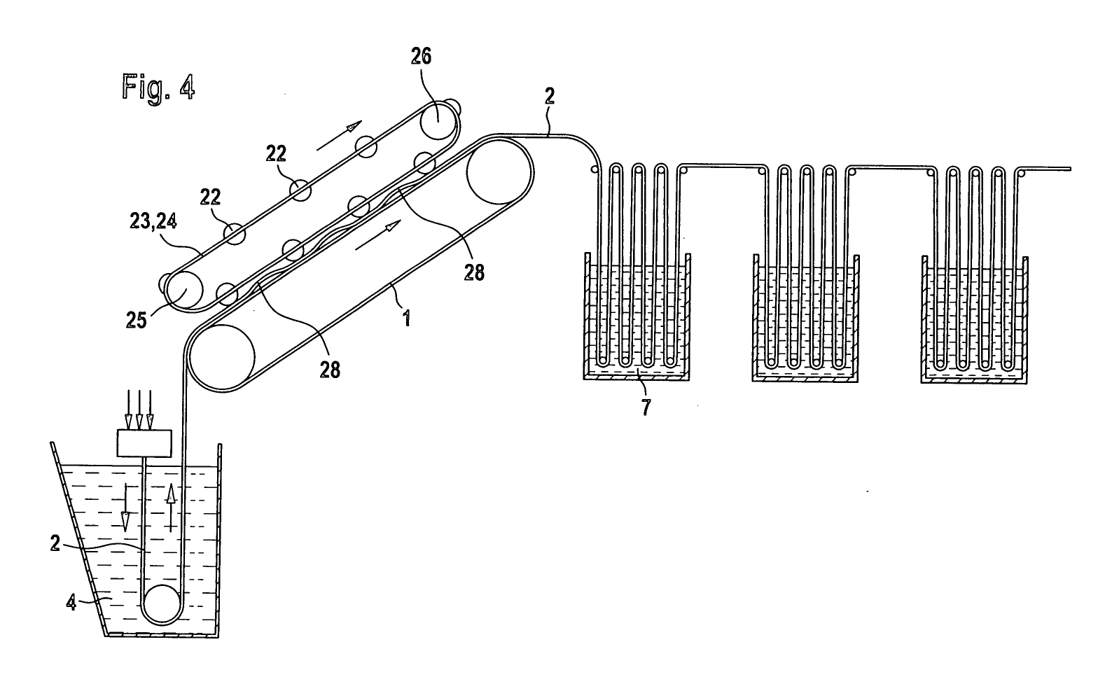

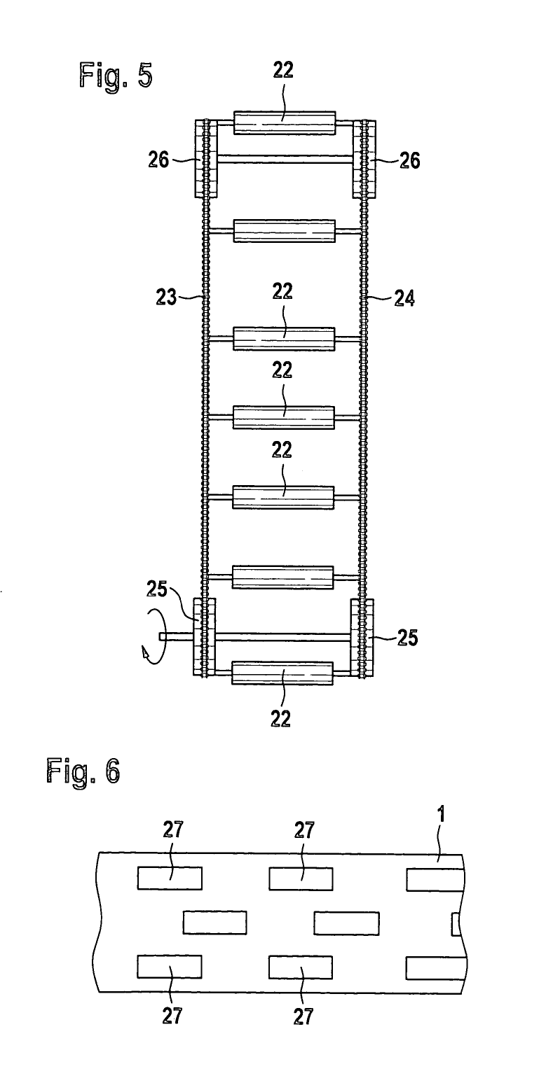

FIGS. 4 and 5 show a fourth embodiment of the invention in which pinch rolls 22 are guided over the surface of the tubular film 2 moved over the conveyor belt 1. Each of these pinch rolls 22 is mounted with its axis able to rotate in two circulating chains 23, 24 as can be seen in FIG. 5. The circulating chains 23, 24 move the pinch rolls 22 in the opposite direction to the running direction of the tubular film 2. The pinch rolls 22 which are moved on the surface of the tubular film 2 cause transport, acting according to the principle of a peristaltic pump, of the NMMO-water mixture in the interior of the tubular film 2 back in the direction of spinning vat 4. In the interior of the tubular film 2, between each pair of pinch rolls liquid bags 28 form which are transported in the direction of the spinning vat 4 in the opposite direction to the transport direction of the tubular film 2. As FIG. 5 shows, the two chains 23, 24 circulate round chain wheel pairs 25, 26, of which one chain wheel pair 25 is driven. The embodiments according to FIGS. 3, 4 and 5 are always used if the transport speed of the tubular film 2 is greater than 35 m/min, in particular 40 to 50 m/min.

FIG. 6 shows a plan view of a section of a conveyor belt 1 which comprises breakthroughs 27. In the same manner, conveyor belts 8 and 9 are equipped with breakthroughs. The breakthroughs are of dimensions such that no embossing occurs on the tubular film. As a result the weight of the conveyor belts is decreased and, furthermore, the tubular film 2 is mechanically loaded only to the extent that this is possible with respect to the gel-like structure of the tubular film 2. However, conveyor belts without such breakthroughs can be used, that is to say conveyor belts having a sealed surface.

### EXAMPLE

An edible tubular film 2 of caliber 22 mm is produced by the NMMO process. The solid portion of the tubular film is 40% cellulose, 10% zein and 50% ground wheat starch. The liquid portion of the total volume of the tubular film wall after exit of the tubular film 2 from the spinning bath 4 is 71%. The tubular film 2 is transported by means of the first embodiment according to FIG. 1 from the spinning vat 4 to the first wash vat 7. After it is sprayed with hot water at 70° C. and passes by the sloping conveyor belt 1, the liquid portion is measured, and it is 39% by weight. The same liquid portion is measured at the end of the wet treatment, that is to say after passing through the entire wash path which comprises up to four or five wash vats. It may be concluded therefrom that during the entire wash operation an exchange of liquid between the tubular film wall and the wash environment takes place, but the total volume of the tubular film wall remains essentially unchanged. As a result, only very small collections of NMMO-water mixture will occur in the interior of the tubular film 2, so that a considerable prolongation of the cutting intervals for the tubular film 2 for removing the liquid accumulations occurs. The uncut tubular film length is increased by at least a factor of 4 compared with the conventional process in which neither sloping transport of the tubular film from spinning vat to wash vat takes place nor is it sprayed with a hot wash liquid.

What is claimed is:

1. A process for removing a NMMO-water mixture collecting in the interior of a tubular film produced by the N-methylmorpholine N-oxide (NMMO) process which comprises passing a tubular film, after exit from a spinning vat, over a path upward at an incline to a wash vat and NMMO-water mixture situated in the tubular film interior flows back via the inclined path into a part of the tubular film which is descending vertically in the spinning vat and from there the NMMO-water mixture is sucked out of the tubular film.

2. The process as claimed in claim 1, wherein, to compact the tubular film wall and for accelerated depletion of the NMMO-water mixture in the tubular film, the tubular film is treated with hot wash liquid at from about 60° C. to about 80° C.

3. The process as claimed in claim 2, wherein the treatment with hot wash liquid is performed along the inclined path.

4. The process as claimed in claim 3, wherein the tubular film is sprayed with the hot wash liquid along the inclined path.

5. The process as claimed in claim 2, wherein the wash liquid is water.

6. The process as claimed in claim 1, wherein the tubular film is continuously passed from the spinning vat upward to the wash vat across the inclined path at an angle of from about 10° to about 60° to the horizontal.

7. The process as claimed in claim 1, wherein the tubular film is passed over an ascending serpentine-like path from the spinning vat to the wash vat.

8. The process as claimed in claim 1, wherein the inclination of the path is adjustable.

9. The process as claimed in claim 1, wherein NMMO-water mixture situated in the tubular film wall and in the tubular film interior is squeezed out along the inclined path.

10. The process as claimed in claim 9, wherein the NMMO-water mixture situated in the tubular film wall and in the tubular film interior is squeezed out in the running direction of the tubular film at the same speed as the conveyor belt moves.

11. The process as claimed in claim 9, wherein the NMMO-water mixture is squeezed out along the entire path at a plurality of sites or only at the higher end of the path.

12. An apparatus for removing a NMMO-water mixture collecting in the interior of a tubular film produced by the N-methylmorpholine N-oxide (NMMO) process, in which at least one conveyor belt which circulates endlessly over two rollers is disposed between a spinning vat and a wash vat and is directed upward at an incline toward the wash vat, and the tubular film which runs vertically downward in the interior of the spinning vat and, after its reversal, runs vertically upward, is passed over the inclined conveyor belt toward the wash vat.

13. The apparatus as claimed in claim 12, wherein a plurality of conveyor belts are disposed between the spinning vat and the wash vat, each conveyor belt circulates endlessly over two rollers and the conveyor belts are oriented in a zigzag shape one above the other.

14. The apparatus as claimed in claim 13, wherein a reversal roller is present between in each case two conveyor belts and the tubular film is passed from the spinning vat in a serpentine-like manner over the top runs of the conveyor belts and the reversal rollers to the wash vat.

15. The apparatus as claimed in claim 12, wherein a spray device having a number of spraying nozzles for spraying the tubular film with wash liquid is disposed above the conveyor belt.

16. The apparatus as claimed in claim 13, wherein in each case one spray device having a number of spraying nozzles is mounted above one, or two or all conveyor belts.

17. The apparatus as claimed in claim 12, wherein a pinch-roll pair is disposed near the top end of the conveyor belt, the tubular film passes through between the pinch-roll pair and the pinch-roll pair circulates in the opposite direction to the transport direction of the tubular film.

18. The apparatus as claimed in claim 13, wherein a pinch-roll pair is disposed near the top end of the central or top conveyor belt, the tubular film runs through between the pinch-roll pair and the pinch-roll pair circulates in the opposite direction to the transport direction of the tubular film.

19. The apparatus as claimed in claim 12, wherein a plurality of pinch rolls lie against the surface of the tubular film which is transported over the conveyor belt, and the pinch-rolls are mounted with their axles so as to be able to rotate in two circulating chains and circulate in the opposite direction to the transport direction of the tubular film at a variable speed.

20. The apparatus as claimed in claim 12, wherein the conveyor belt and the spray device are adjustable vertically in a manner such that their angle of inclination to the horizontal is from about 10° to about 60°.

21. The apparatus as claimed in claim 12, wherein the circulation speed of the pinch-roll pairs is variable.

22. The apparatus as claimed in claim 12, wherein the conveyor belts are equipped with breakthroughs.

23. A process for removing a liquid collecting in an interior part of a tubular film which comprises passing a tubular film having an interior part along a vertically descending path through a liquid in a spinning vat, and then removing the tubular film from the spinning vat along a vertically ascending path through the liquid in the spinning vat, and then passing the tubular film over an upwardly inclined path toward a wash vat such that liquid in the interior part of the tubular film flows back via the inclined path into a part of the interior of the tubular film which is in the vertically descending path in the spinning vat, and sucking liquid out of the part of the interior of the tubular film which is in the vertically descending path.

24. The process of claim 23 wherein the tubular film is sprayed with hot water at from about 60° C. to about 80° C. along the upwardly inclined path.

25. The process of claim 23, wherein the upwardly inclined path comprises and ascending serpentine-like path from the spinning vat to the wash vat.
